(19) United States
(12) Patent Application Publication
(10) Pub. No.: US 2005/0074037 A1
(43) Pub. Date: Apr. 7, 2005

(54) Optical sub-carrier multiplexed transmission

(76) Inventors: Robin Rickard, Spellbrook (GB); Jullan Fells, Epping (GB); Richard Epworth, Sawbridgeworth (GB)

Correspondence Address: BARNES & THORNBURG, P.O. BOX 2786, CHICAGO, IL, 60690-2786, US

(21) Appl. No.: 10/679,824

(22) Filed: Oct. 6, 2003

(51) Int. Cl. H04J 3/02

(52) U.S. Cl. 370/537; 370/210

(57) ABSTRACT

Apparatus for generating and receiving optical sub-carrier multiplexed signals has a digital signal processor for performing a Fourier transform, to generate or receive the optical sub-carrier multiplexed signal. This apparatus enables the generation and reception of the optical sub-carrier multiplexed signal in a single apparatus, giving cost and complexity savings over conventional methods of receiving each sub-carrier in an independent apparatus. Due to the use of Fourier transforms the sub-carrier spacing can be reduced to 1/(Symbol period) giving improvements in the spectral efficiency of the system

### FIELD OF THE INVENTION

This invention relates to sub-carrier multiplexed modulation formats for optical communications, and to transmitters and receivers for optical communications systems, employing sub-carrier multiplexed modulation formats.

### BACKGROUND TO THE INVENTION

Capacity of known optical communications systems is limited by factors such as the number of wavelengths that can be transmitted along an optical path, the ability of the receiver to recover the transmitted signal and the ability to compensate for impairments in the transmission medium.

Chromatic Dispersion (CD) in the link between transmitter and receiver can cause Inter Symbol Interference (ISI), due to the ‘blurring’ of one symbol period into the adjacent symbol periods. CD occurs due to different wavelengths of light propagating at different velocities. As the symbol rate of each signal is increased the tolerance to CD gets smaller, due to the reduced symbol period. In order to compensate for CD, Dispersion Compensation Modules (DCMs) are typically used. These compensate for the dispersion in the optical domain, however add significant cost to the system.

A further known degradation of optical communications systems is Polarisation Mode Dispersion (PMD). PMD is caused by the fact that different polarisations propagate at different velocities, and hence symbol periods may become blurred as they propagate along the link. PMD is a function of wavelength, and the amount of PMD at each wavelength in a link changes over time due to changes and movement of the fibre in the link. It is therefore not possible to implement a static PMD compensation system. Active optical PMD compensation has been performed, however has proved economically unviable.

Signals in optical links are also degraded by non-linear coupling of intensity and phase, which can act either within a single channel, or between multiple channels. Examples of these are self-phase modulation and cross-phase modulation, respectively. Due to their distributed nature, it is very difficult to compensate for them using a discrete device.

The achievable capacity and reach of optical communications systems is thus restricted by a number of effects. As symbol rates increase the impact of each of the effects increases.

In order to communicate data, a carrier signal is modulated with the data. In a conventional modulation format, such as amplitude modulation, a single carrier represents all of the data. Sub-Carrier Multiplexing (SCM) is a modulation format whereby the carrier representing the data consists of a plurality of sub-carriers. Each sub-carrier is modulated independently and thus represents part of the data being represented by the whole carrier.

FIG. 1a shows a typical spectrum of an SCM signal, with four sub-carriers 100a spaced in frequency. Guard bands 101a are provided between sub-carriers such that adjacent sub-carriers do not interfere with one another. The modulation format utilised to modulate each sub-carrier can be chosen according to the system requirements.

The symbol rate of an SCM signal is therefore defined by the number of sub-carriers, and the modulation format utilised for each sub-carrier. For example if four binary modulated sub-carriers are utilised the symbol rate will be a quarter of the bit rate carried by the SCM signal. Alternatively if four quadrature modulated sub-carriers are utilised, the symbol rate will be one eighth of the bit rate carried by the SCM signal.

According to systems of the prior art, each sub-carrier is generated independently by modulation of individual carriers, which are then combined to yield a sub-carrier multiplexed signal. This technique has the disadvantage that individual apparatus may be provided to generate each sub-carrier, substantially increasing the cost of the system. Furthermore the guard bands between sub-carriers reduce the spectral efficiency of the modulation format, reducing the data capacity of an optical communications system.

Henceforth the term ‘composite signal’ will be used to describe the set of sub-carriers representing a data stream.

### SUMMARY OF THE INVENTION

According to one aspect of the present invention, there is provided apparatus for generating an optical sub-carrier multiplexed signal, comprising
a digital signal processor having a plurality of electrical inputs, in use each receiving an input signal representing data to be carried on a sub-carrier of the optical sub-carrier multiplexed signal, and an electrical output outputting an output signal, and
a modulator having an electrical input, in use receiving the output signal from the digital signal processor, and an optical output, in use outputting the optical sub-carrier multiplexed signal,
wherein the output signal of the digital signal processor is the result of a Fourier transform performed on the input signals.

This apparatus enables the transmission of an optical sub-carrier multiplexed signal. All of the sub-carriers in the signal are generated in a single apparatus, offering significant cost savings, and reduction in complexity over previous apparatus where each sub-carrier was generated independently.

Another additional feature for a dependent claim is where the spacing of the sub-carriers in the sub-carrier multiplexed signal is substantially equal to an integer multiple of 1/(Symbol period).

By reducing the frequency spacing of the sub-carriers the spectral efficiency of a transmission system utilising the present invention can be increased. When the sub-carrier is equal to 1/(Symbol period) the sub-carriers overlap in the frequency space, and with traditional implementations would interfere with one another. In the present invention the use of a Fourier transform enables sub-carriers to be received if their spacing is 1/(Symbol period) even though they overlap in the frequency space.

Another additional feature for a dependent claim is a mapper having an electrical input, in use receiving binary data, and a plurality of electrical outputs connected to the electrical inputs of the digital signal processor, wherein the signals carried by the outputs are a representation of the binary data according to a predetermined modulation format.

Each sub-carrier of the optical sub-carrier multiplexed signal can be modulated according to any predetermined modulation format. Each modulation format has particular advantages and disadvantages, as is well known to those skilled in the relevant art. Broadly the modulation format may be a phase modulation format, an amplitude modulation format, or a combination of both. Phase modulation formats may utilise either differential or absolute encoding of the phase.

Another additional feature for a dependent claim is the digital signal processor further comprising a serialiser, having a plurality of electrical inputs connected to the electrical outputs of the digital signal processor, and an electrical output in use carrying a signal generated by the serialisation of the signals carried on the plurality of electrical inputs to the serialiser.

The output of the Fourier transform is a parallel set of signals, to enable a conventional optical modulator to be utilised these signals may be serialised.

Another additional feature for a dependent claim is a digital to analogue converter having an electrical input connected to the electrical output of the digital signal processor, and an electrical output connected to the modulator, in use the output of the digital to analogue converter being an analogue representation of the digital input signal.

Conventional optical modulators require an analogue voltage or current to modulate the optical carrier. The processing of the apparatus is performed in the digital domain, and hence the output values may be converted to analogue signals in order to drive conventional modulators.

Another additional feature for a dependent claim is an electrical signal generator, connected to an input of the modulator, wherein a small depth modulation is imparted on the optical sub-carrier multiplexed output signal.

In order to lock correctly to the received signal a known frequency is required at the receiver. A signal generator is utilised to modulate the transmitted signal with a small depth modulation which can be detected at the receiver and utilised to acquire the signal.

Another additional feature for a dependent claim is apparatus wherein the modulator is configured to modulate the amplitude and phase of an optical carrier.

In order generate an optical sub-carrier multiplexed signal the amplitude and phase of the carrier may be modulated. It is advantageous if this modulation is performed in a single device, as this offers cost savings and simplification of the hardware.

In an additional feature for a dependent claim the modulator comprises two Mach-Zehnder structures, connected to an optical combiner.

This is an efficient structure of producing an amplitude and phase modulated carrier.

In an additional feature for a dependent claim the modulator comprises
an electrical signal modulator having an electrical signal input, in use receiving the output of the digital signal processor, an electrical carrier input in use receiving a carrier signal, wherein the carrier is modulated in response to the electrical signal input to generate a modulated electrical signal which is output on an electrical output,
an optical modulator having an optical input in use receiving an optical carrier and an electrical input connected to the output of the electrical signal modulator, wherein the optical carrier is modulated in response to the output of the electrical signal modulator.

The optical modulator may be an amplitude or a phase modulator.

Modulating both the amplitude and phase of an optical carrier is expensive and complex. This apparatus requires an optical modulator capable of modulating only one of the amplitude or phase of the optical carrier, hence giving cost and complexity reductions.

Another additional feature for a dependent claim is a forward error correction coder connected to the digital signal processor, in use applying forward error correction coding to the data.

Forward error correction coding allows the performance of a communication system to be improved, by detecting and correcting errors in the data at the receiver. By utilising forward error correction coding errors due to phenomena which affect different carriers by different amounts can be preferentially corrected.

In a further aspect of the present invention, there is provided apparatus for generating an optical signal consisting of a plurality of optical sub-carrier multiplexed signals, the apparatus comprising
a plurality of digital signal processors each having
a plurality of electrical inputs, in use each input receiving an input signal representing data to be carried on a sub-carrier of the optical sub-carrier multiplexed output signal, and
an electrical output carrying an output signal,
wherein, the electrical output signal of each digital signal processor is the result of a Fourier transform performed on the respective inputs of that digital signal processor,
a plurality of electrical signal modulators each having an electrical signal input, in use receiving the output of a digital signal processor,
an electrical carrier input in use receiving a carrier signal, wherein the carrier is modulated in response to the electrical signal input to generate a modulated electrical signal, and
an electrical output outputting the modulated electrical signal, an electrical combiner having
a plurality of electrical inputs, in use each input receiving the output of one of the electrical signal modulators, and
an electrical output in use carrying a signal generated by combining the input signals, and,
an optical modulator having
an electrical input in use receiving the output of the electrical combiner,
an optical carrier input, in use receiving an optical carrier, and
an optical output, in use outputting the plurality of optical sub-carrier multiplexed signals.

In an additional feature the optical modulator may be either an amplitude or a phase modulator.

This apparatus allows multiple sub-carrier multiplexed signal to be carried by a single optical carrier, via the analogue combination of the electrical signals. This is advantageous as it allows maximum use to be made of the bandwidth of the optical modulator. Furthermore only the amplitude or phase of the optical signal needs to be modulated, thus avoiding the expense and complexity of modulating both amplitude and phase.

In a further aspect of the present invention, there is provided an optical transmitter comprising
a digital signal processor having a plurality of electrical inputs, in use each receiving an input signal representing the data to be carried on a sub-carrier of the optical sub-carrier multiplexed signal, and an electrical output outputting an output signal, and
a modulator having an electrical input, in use receiving the output signal from the digital signal processor, and an optical output, in use outputting the optical sub-carrier multiplexed signal,
wherein the output signal of the digital signal processor is the result of a Fourier transform performed on the input signals.

A transmitter capable of transmitting an optical sub-carrier multiplexed enables optical sub-carrier multiplexed signals to be utilised within an optical communications system with the advantages described above.

According to a further aspect of the present invention there is provided apparatus for receiving an optical sub-carrier multiplexed signal, comprising
an optical to electrical converter, in use receiving the optical sub-carrier multiplexed signal and outputting an electrical signal, and
a digital signal processor having an electrical input, in use receiving the output of the optical to electrical converter, and a plurality of electrical outputs, in use each carrying a signal representing data carried on a sub-carrier of the optical sub-carrier multiplexed signal,
wherein, the outputs of the digital signal processor are the result of a Fourier transform performed on the input signal.

Conventional receivers for optical sub-carrier multiplexed signals have received each sub-carrier independently and processed them to obtain the data. The present invention utilises one digital signal processor and associated equipment to receive the entire sub-carrier multiplexed signal. This enables a simpler and more cost effective receiver to be constructed. Furthermore it has the advantage of enabling the reception of sub-carrier multiplexed signals where the carriers are spaced at 1/(Symbol period), and hence overlap, with the advantages described above.

Another additional feature for a dependent claim is a decoder having
a plurality of electrical inputs in use receiving the outputs of the digital signal processor, and
an electrical output, in use outputting binary data.

The output of the Fourier transform is a set of parallel signals. By utilising the above decoder the output data can be formatted to a format suitable for use by equipment connected to the receiving apparatus.

Another additional feature for a dependent claim is a decoder comprising a serialiser having a plurality of inputs receiving the outputs of the digital signal processor, and an output outputting a signal derived by the serialisation of the input signals.

A convenient way of obtaining a data stream of the required format from a parallel signal is via the use of serialiser.

Another additional feature for a dependent claim is a decoder comprising a threshold decoder, wherein the output data is determined by the comparison of the input signals with a predetermined value. Alternatively the decoder comprises a maximum likelihood sequence estimation decoder.

In order to obtain binary data from the receiver the outputs of the Fourier transform may be interpreted. This may be performed by comparing the values with a threshold value, or by the application of a maximum likelihood sequence estimation process. Threshold detection is simple and inexpensive to implement, however the use of maximum likelihood sequence estimation improves the performance of a receiver.

Another additional feature for a dependent claim is a digital signal processor comprising
a de-serialiser having an electrical input receiving the output of the optical to electrical converter and outputting a plurality of signals obtained by the deserialisation of the input,
a Fourier transform unit having a plurality of electrical inputs, in use receiving the outputs of the de-serialiser, and a plurality of electrical outputs, in use each carrying a signal representing data carried on a sub-carrier of the optical sub-carrier multiplexed signal,
wherein the electrical outputs of the Fourier transform unit are the result of a Fourier transform performed on the inputs.

The output of a conventional optical to electrical converter is likely to be a serial signal. The input to the Fourier transform is a parallel signal, and hence to enable the use of a conventional optical to electrical converter the signal may be deserialised.

Another additional feature for a dependent claim is a forward error correction decoder connected to the digital signal processor, performing error correction on the data.

By applying forward error correction coding in to the transmitted sub-carriers the performance of the system can be improved.

Another additional feature for a dependent claim is apparatus to determine channel state information of the sub-carriers. This information can be utilised by the forward error correction decoder to improve the performance.

By determining the state of each sub-carrier, additional information can be provided to the error correction system to improve the performance of the error detection and correction.

Another additional feature for a dependent claim is an optical coupler, having
a plurality of optical inputs, in use one of said inputs receiving the optical sub-carrier multiplexed signal, and another of said inputs receiving the output of an optical local oscillator, and
a plurality of optical outputs, at least one of said outputs being connected to the optical to electrical converter.

In order to receive the optical sub-carrier multiplexed signal, in phase and quadrature components of the signal may be obtained. This is advantageously performed by mixing the signal with an optical local oscillator.

Another additional feature for a dependent claim is apparatus for receiving a plurality of optical sub-carrier multiplexed signals, comprising an optical demultiplexer having an optical input in use receiving the plurality of optical sub-carrier multiplexed signals, and a plurality of optical outputs in use each output carrying at least one of the optical sub-carrier multiplexed signals, wherein the outputs are connected to apparatus described previously for the reception of sub-carrier multiplexed signal.

When a plurality of optical sub-carrier multiplexed signals are transmitted on a single communications link, the signals may be separated to enable them to be independently performed. By performing this separation in the optical domain, the electrical section of the receiver is simplified.

In a further aspect of the present invention there is provided apparatus for receiving a plurality of optical sub-carrier multiplexed signals, comprising
an optical to electrical converter having
an optical input, in use receiving the optical sub-carrier multiplexed signals, and
an electrical output in use outputting an electrical signal representative of the amplitude of the optical sub-carrier multiplexed signals,
an electrical splitter having
an electrical input, in use receiving the output of the optical to electrical converter, and
a plurality of electrical outputs, in use each outputting a predetermined fraction of the input signal,
a plurality of electrical demodulators, each having
an electrical input, in use receiving an output of the electrical splitter, an electrical local oscillator input in use receiving an electrical signal from an electrical oscillator, and
an electrical output, in use outputting a demodulated signal,
wherein each electrical oscillator outputs a signal with a different frequency corresponding to a frequency associated with each of the plurality of sub-carrier multiplexed signals,
a plurality of digital signal processors each having
an electrical input, in use receiving the output of an electrical demodulator, and
a plurality of electrical outputs, in use each carrying a signal representing data carried on a sub-carrier of the optical sub-carrier multiplexed signals,
wherein, the outputs of each digital signal processor are the result of a Fourier transform performed on the respective input signals.

This apparatus has the advantage of receiving a plurality of optical sub-carrier multiplexed signals in a single receiver system. This simplifies the optical section of the receiver which leads to improved performance by the removal of degradation due to the optical section.

In a further aspect of the present invention there is provided a receiver for use in an optical communications system comprising
an optical to electrical converter, in use receiving the optical sub-carrier multiplexed signal and outputting an electrical signal, and
a digital signal processor having an electrical input, in use receiving the output of the optical to electrical converter, and a plurality of electrical outputs, in use each carrying a signal representing data carried on a sub-carrier of the optical sub-carrier multiplexed signal,
wherein, the outputs of the digital signal processor are the result of a Fourier transform performed on the input signal.

By providing an optical sub-carrier multiplexed receiver the utilisation of sub-carrier multiplexed transmission in optical communications systems is enabled.

In a further aspect of the present invention there is provided a method for generating an optical sub-carrier multiplexed signal, having the steps of:
performing a Fourier transform on a plurality of signals, each signal representing data to be carried on a sub-carrier of the optical sub-carrier multiplexed signal, and
modulating an optical carrier with the signal output from the Fourier transform to generate an optical sub-carrier multiplexed signal.

This method produces all of the sub-carriers of an optical sub-carrier multiplexed signal in a single piece of equipment, giving cost savings and improved performance over previously known techniques utilising duplicate equipment for each sub-carrier.

An additional feature for a dependent claim is that the sub-carriers are generated with a spacing substantially equal to an integer multiple of 1/(Symbol period).

This has the advantages described above.

Another additional feature for a dependent claim is the step of receiving electrical data and mapping it according to a predetermined modulation format to form the inputs to the Fourier transform.

The provision of a mapper enables the input data to be of an arbitrary format, which can be mapped by the apparatus to the modulation format chosen.

Another additional feature for a dependent claim is the step of applying forward error correction in to the data.

The use of forward error correction coding enables errors due to degradations which affect different carriers by different amounts to be preferentially corrected.

Another additional feature for a dependent claim is the step of serialising the output signals of the Fourier transform.

The output of the Fourier transform is a set of parallel signals, it is advantageous to serialise these signals into a required serial format for output to other equipment.

According to a further aspect of the present invention there is provided a method for receiving an optical sub-carrier multiplexed signal, having the steps of:
converting the optical signal to an electrical signal, and
performing a Fourier transform on the electrical signal to obtain a plurality of electrical signals, each signal representing the data carried on one of the sub-carriers of the optical sub-carrier multiplexed signal.

The use of a Fourier transform enables all sub-carriers of a sub-carrier multiplexed signal to be received in a single apparatus, offering cost savings and performance enhancements over conventional receivers which receive each sub-carrier independently. Furthermore the reception of signals with sub-carriers spaced at 1/(Symbol period) can be received.

Another additional feature for a dependent claim is the step of serialising the signals output from the Fourier transform to obtain a substantially serial data stream.

Another additional feature for a dependent claim is the step of decoding the output signals of the Fourier transform according to a threshold decision rule. Maximum likelihood sequence estimation may also be utilised.

The outputs of the Fourier transform may be decoded to obtain the binary data carried by the sub-carriers. This may be performed utilising a threshold decision system which provides a simple and cheap method of obtaining the data. Maximum likelihood sequence estimation may also be utilised, giving improved performance and compensation for non-linearities in the transmission.

Another additional feature for a dependent claim is the step of decoding forward error correction applied to the data.

The use of forward error correction coding enables errors due to degradations which affect different carriers by different amounts to be preferentially corrected.

Another additional feature for a dependent claim is the step of obtaining channel state information on the sub-carriers, indicative of the quality of each sub-carrier. This information can be utilised to control the behaviour of the forward error correction.

By determining the state of each sub-carrier, additional information can be provided to the error correction system to improve the performance of the error detection and correction.

In a further aspect of the present invention there is provided a method of optical communication utilising an optical sub-carrier multiplexed signal, having the steps of
performing a Fourier transform on a plurality of signals, each signal representing data to be carried on a sub-carrier of the optical sub-carrier multiplexed signal,
modulating an optical carrier with the signal output from the Fourier transform to generate an optical sub-carrier multiplexed signal,
transmitting the optical sub-carrier multiplexed signal from one location to a second remote location,
converting the optical sub-carrier multiplexed signal to an electrical signal,
performing a Fourier transform on the electrical signal to obtain a plurality of electrical signals, each signal representing the data carried on one of the sub-carriers of the optical sub-carrier multiplexed signal.

The use of optical sub-carrier multiplexed transmission and Fourier transforms to generate and receive the signals enables the performance of optical transmission systems to be improved.

According to a further aspect of the present invention there is provided an optical signal carrying data, having a plurality of sub-carriers spaced at an integer multiple of 1/(Symbol period).

An optical signal with a plurality of sub-carriers enables data to be communicated with a symbol rate significantly lower than the bit rate. This reduces the degradations due to a number of phenomena giving improved performance, as described above. Spacing the sub-carriers at an integer multiple of 1/(Symbol period) increases the spectral efficiency of the signal.

According to a further aspect of the present invention there is provided a transmitter comprising a digital signal processor coupled to an optical signal generator, the transmitter being arranged, in use, to generate an optical data signal having a plurality of sub-carriers.

The use of digital signal processing to generate a signal with a plurality of sub-carriers enables the entire signal to be generated in a single apparatus. Previously individual apparatus has been required for each sub-carrier, having the disadvantages described above.

A further feature for a dependent claim is that the optical data signal is an orthogonal frequency division multiplexed signal.

This has the advantage of providing an improved spectral efficiency.

According to a further aspect of the present invention there is provided a method of generating an optical data signal having a plurality of sub-carriers, having the steps of:
receiving an electrical data signal,
processing the electrical data in a digital signal processor, and
generating an optical sub-carrier multiplexed signal according to the output of the digital signal processor.

This has the advantage of generating all of the sub-carriers in a single process thus improving the efficiency and simplicity of the apparatus.

A feature for a dependent claim is the optical data signal being an orthogonal frequency division multiplexed optical signal.

This has the advantage of providing an improved spectral efficiency.

According to a further aspect of the present invention there is a provided a receiver comprising an optical to electrical converter coupled to a digital signal processor, the receiver being arranged, in use, to receive an optical data signal having a plurality of sub-carriers.

The use of digital signal processing to receive a signal with a plurality of sub-carriers enables the entire signal to be received in a single apparatus. Previously individual apparatus has been required for each sub-carrier, having the disadvantages described above.

A feature for a dependent claim is the optical data signal being an orthogonal frequency division multiplexed signal.

This has the advantage of providing an improved spectral efficiency.

According to a further aspect of the present invention there is provided a method of receiving an optical data signal having a plurality of sub-carriers, having the steps of:
converting the optical data signal to an electrical signal, and
processing the electrical signal in a digital signal processor.

The use of digital signal processing to receive a signal with a plurality of sub-carriers enables the entire signal to be received in a single apparatus. Previously individual apparatus has been required for each sub-carrier, having the disadvantages described above.

A feature for a dependent claim is the optical data signal being an orthogonal frequency division multiplexed optical signal.

This has the advantage of providing an improved spectral efficiency.

According to a further aspect of the present invention there is provided an optical communications system comprising an apparatus, transmitter or receiver according to any one of claims 1, 18, 21, 23, 36, 35, 53 or 55.

This system has all of the advantages described above in relation to the transmitter, receiver and signals utilised.

According to a further aspect of the present invention there is provided an optical communications system comprising a transmitter and a receiver, in use the transmitter transmitting an optical data signal to the receiver, wherein the optical data signal is an orthogonal frequency division multiplexed signal.

This system has all of the advantages described above in relation to the transmitter, receiver and signals utilised.

Software for carrying out the method of any one of claims 37, 43, 51, 55 or 59.

This has the advantages described above in relation to each of the methods.

Any of the above features can be combined together or combined with any of the aspects of the invention as would be apparent to those skilled in the art. Other advantage will be apparent to those skilled in the art.

There now follows, by way of example only, a detailed description of preferred embodiments of the present invention in which:

### BRIEF DESCRIPTION OF THE DRAWINGS

FIG. 1a is a diagram showing a typical sub-carrier multiplexed signal spectrum, as known in the prior art;

FIG. 1 is a flow diagram showing a method of optical communications utilising SCM and Forward Error Correction (FEC) coding according to the present invention;

FIG. 2 is a block diagram showing an example of a transmitter system according to the present invention;

FIG. 2a is a diagram showing a modulation constellation according to the present invention;

FIG. 3 is a block diagram showing an example of a transmitter system according to the present invention;

FIG. 4 is a block diagram of a receiver for receiving all sub-carriers together, according to the present invention;

FIG. 5 is a block diagram of a receiver for receiving sub-carriers independently according to the present invention;

FIG. 6 is a detailed block diagram of a receiver according to the present invention;

FIG. 7 is a block diagram of a receiver for receiving a signal generated according to the equipment of 3, according to the present invention;

FIG. 8 is a flow diagram of a method of generating an optical sub-carrier multiplexed signal, according to the present invention; and

FIG. 9 is a flow diagram of a method of receiving an optical sub-carrier multiplexed signal, according to the present invention.

### DETAILED DESCRIPTION OF PREFERRED EMBODIMENTS OF THE INVENTION

The present invention describes optical communication utilising Sub-Carrier Multiplexing (SCM) and digital signal processing. The use of SCM transmission in an optical communication system is beneficial as it allows the symbol rate to be reduced, thus increasing tolerance to Chromatic Dispersion (CD) and Polarisation Mode Dispersion (PMD), allowing increased reach. Furthermore the use of digital signal processing overcomes the problems previously discussed when using analogue techniques with SCM. Particularly, removing the need for many sets of apparatus at the transmitter to generate the sub-carriers, as required by analogue SCM generation techniques, and avoiding reduced spectral efficiency due to the guard bands conventionally required between sub-carriers.

In the present invention digital signal processing in the receiver enables the sub-carrier spacing to be reduced, such that the sub-carriers overlap, thus improving spectral efficiency. Sub-carriers are spaced at an integer multiple of 1/(Symbol period) and by integrating over a symbol period in the receiver adjacent sub-carriers appear orthogonal and hence do not interfere, even though they overlap. For example with a typical configuration the sub-carrier spacing may be 3.3 GHz, compared to tens of GHz for a conventional analogue SCM system. Modulation formats with the sub-carriers spaced at an integer multiple of 1/(Symbol period) are henceforth referred to as Orthogonal Frequency Division Multiplexed (OFDM) modulation formats.

It will be understood that OFDM modulation is a specific implementation of SCM modulation, and in this document the term SCM, and cognate terms, are intended to include OFDM.

Tolerance to CD and PMD can be further improved via the use of guard intervals at the beginning of each symbol. Due to its location at the start of the symbol period, the guard interval suffers any inter-symbol interference due to dispersive effects, such as CD and PMD, and protects the data carrying portion of the symbol. The guard interval is discarded at the receiver, thus removing the impact of dispersion on the received data symbols. The guard interval is a period of time added to each symbol, which is distinct from the guard band, which is a frequency space required between each sub-carrier in a sub-carrier multiplexed system.

In addition to the increased tolerance to CD and PMD due to the increased symbol period, further advantage can be gained due to the frequency-domain properties of PMD. The shape of the degradation due to PMD, against optical frequency is random, and changes over time, with a characteristic period of tens of milliseconds. Since each sub-carrier is located at a different optical frequency, it is degraded by a different amount to the other sub-carriers in a given composite signal.

Forward Error Correction (FEC) enables errors imparted on data during transmission to be detected and corrected, by transmitting additional information along with the data.

The error correction ability of FEC codes can be improved if bits of known poor quality are declared as erasures to the decoding system.

Channel state information can be utilised to monitor the performance of each individual sub-carrier, and thus the system is aware of the relative performance of each sub-carrier. The characteristic period over which the spectral shape of PMD degradations evolve is tens of milliseconds, thus the channel state information can easily track the current state of each carrier.

It is possible to determine which bits of data have come from which carriers, and thus data from carriers which are known to be of poor quality can be declared to the FEC decoder as erasures, thus improving the performance of the error correction system.

Non-linear effects such as cross-phase modulation and self phase modulation may cause a loss of orthogonality between sub-carriers. This is a deterministic effect and as such Maximum Likelihood Sequence Estimation (MLSE) decoding can be applied in parallel across the composite signal to further improve system performance. The use of MLSE decoding in closely coupled channels is discussed in co-pending U.S. application Ser. No. 10/425,809 hereby incorporated herein by reference.

Preferred embodiments of the present invention will now be described with reference to the figures, beginning with an overview of the communications system before preferred embodiments of the transmitter and receiver are described. Finally, methods according to the present invention are described.

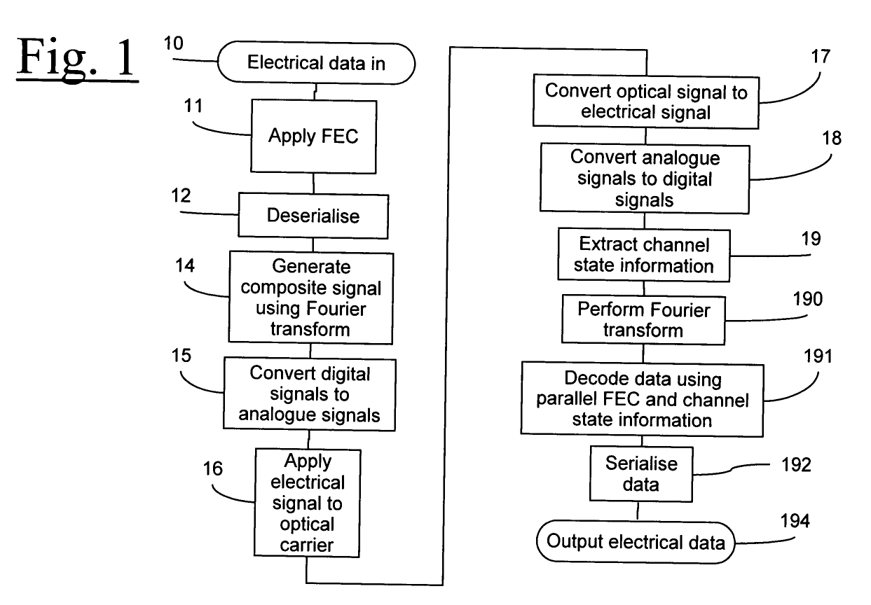

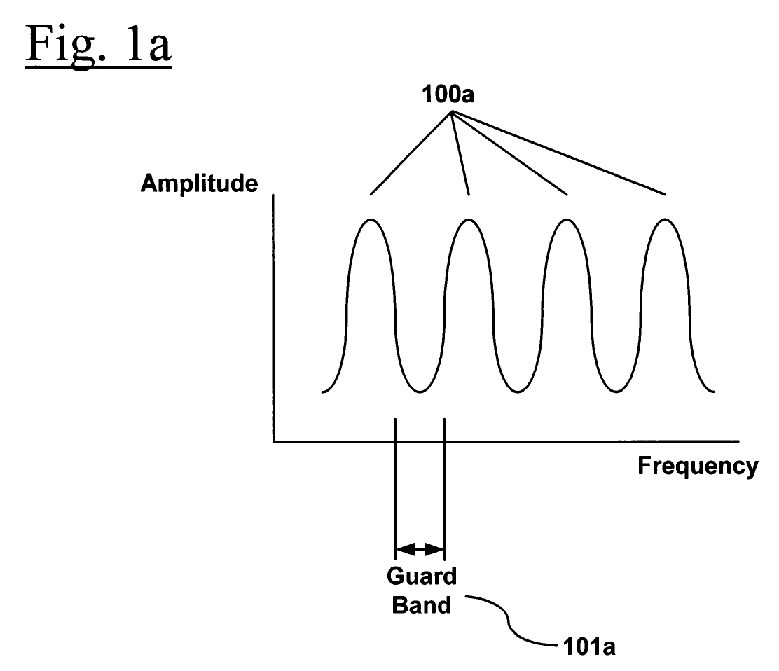

FIG. 1 is a flow diagram showing a method of optical communications utilising SCM and FEC coding. FEC coding is applied at step 11 to the incoming data 10 which is then passed to the SCM coding system. The digital composite signal is generated at step 14 utilising a Fourier transform. This signal is converted to an analogue signal at step 15 and applied to an optical carrier utilising an optical modulator at step 16. The composite optical signal propagates through a system to a receiver where it is converted back to the electrical domain at step 17 before being converted to a digital signal at step 18. Channel state information is extracted from the data at step 19, which is used by the decoding system to improve the performance of error detection and correction. A Fourier transform is applied to the signal at step 190, generating a substantially parallel stream of symbols. FEC codes applied at the transmitter can be utilised to decode the symbols, in conjunction with channel state information at step 191. The output from the decoder is serialised at step 192 to produce a substantially serial data stream 193, of a comparable format to that input to the transmitter.

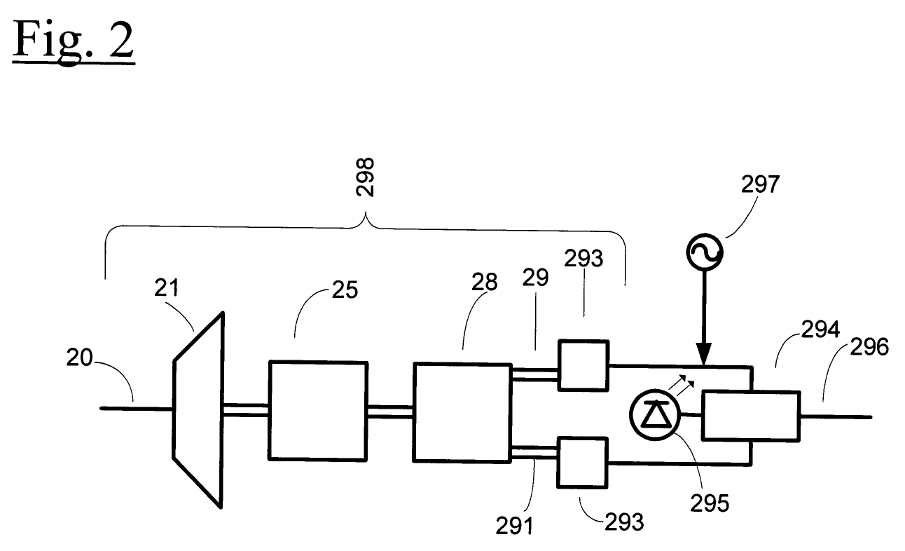

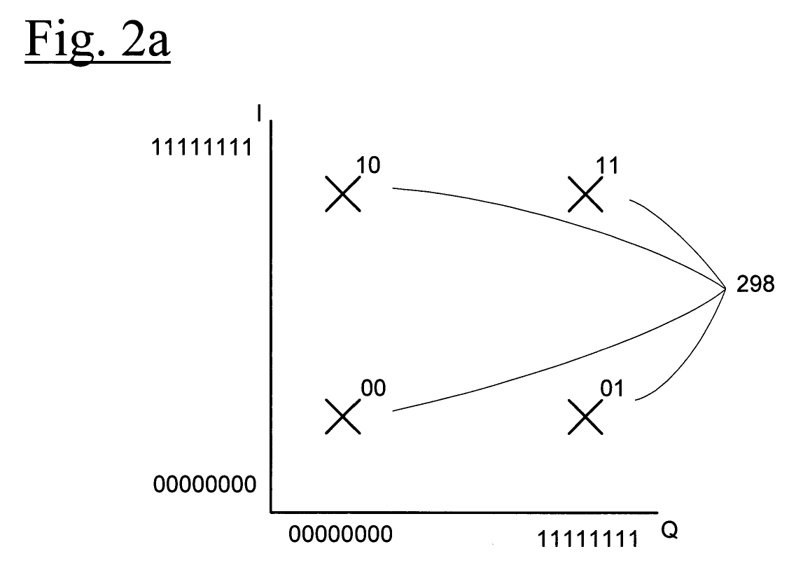

FIG. 2 is a block diagram showing an example of a transmitter system according to the present invention. To aid explanation, an example configuration is described. The example has an input 20 carrying a signal with a data rate of 10 Gb/s (100 ps per bit), and utilises a composite signal with four sub-carriers, each with quadrature modulation.

Firstly the data is deserialised and coded in a coder 21. The data is deserialised into a parallel data stream, with the number of parallel bits being defined by the number of sub-carriers, and the modulation format of each sub-carrier. In our example eight bits are required in parallel (two bits per sub-carrier, four sub-carriers).

The data for each sub-carrier is then mapped to a complex binary number, according to the chosen modulation format. A complex number is typically represented by two orthogonal components, referred to as ‘I’ and ‘Q’, and this convention is utilised in this description. For the purposes of the description only, 8-bits will be utilised to represent ‘I’ and 8-bits to represent ‘Q’, however different numbers of bits may be chosen depending on the requirements of the system as will be obvious to those skilled in the art.

FIG. 2a represents the mapping operation for a quadrature keyed signal, showing the four possible data states 298 to be encoded (00, 01, 10 and 11). If ‘01’ is to be represented on one of the sub-carriers, I=‘00000000’ and Q=‘11111111’ is output on the relevant output. The number of pairs of words output in parallel is defined by the number of sub-carriers, with each I and Q pair corresponding to one sub-carrier. In the example case, eight parallel words will be output—I and Q for each of the four sub-carriers. Each word consists of 8-bits, therefore 64-bits are output every 800 ps.

The parallel data is then passed to a Fourier transform unit, 25. This performs one Fourier transform on each set of parallel input data. The output of the Fourier transform will have the same format as the input, so for our example eight 8-bit words will be output in parallel. The Fourier transform function is also commonly referred to as an Inverse Fourier transform, however both terms have the same meaning in this document.

Each pair of I and Q words output from the Fourier transform represents one time-segment of the symbol to be transmitted, in our example each pair represents 200 ps of the total 800 ps symbol length. In order to generate the required transmitted waveform, the output of the Fourier transform may thus be serialised, which is performed in the multi-bit serialiser 28. In our example the multi-bit serialiser 28 will take 64-bits in, in parallel every 800 ps, and output two 8-bit words (one for 1 and one for Q) in parallel every 200 ps.

Each of these words is then passed to an analogue to digital converter 293, the outputs of which are used to drive the I/Q optical modulator, 294, which modulate an optical carrier, 295, to generate an optical sub-carrier multiplexed signal, output on the optical output, 296. A reference tone 297 may be required at the receiver to enable decoding of the data, and this may be inserted at the modulator. The reference imparts a small depth modulation onto the optical output, which may be detected and recovered at the receiver.

An ‘I/Q optical modulator’ is an optical modulator which can modulate the amplitude and phase of an optical carrier, in response to an electrical input signal. A common way to implement an amplitude and phase modulator is to utilise two independent Mach-Zehnder modulators in parallel, one driven by the I signal and the other by the Q signal. The outputs of these two modulators are then combined, allowing an optical signal with amplitude and frequency defined by the I and Q inputs to be output.

As will be apparent to those skilled in the art there are other techniques allowing the modulation of both amplitude and phase of an optical carrier, and these are equally applicable to the present invention. These alternative techniques may require different drive signals to the I/Q signal described above, in which case additional processing may be performed in the digital signal processor to generate these signals.

Additional digital processing can also be carried out in addition to the actions described above to modify the transmitted waveform. For example non-linearities in the modulator system can be pre-compensated to improve the transmitted waveform. This is achieved by the implementation of a mathematical function in the digital signal processing.

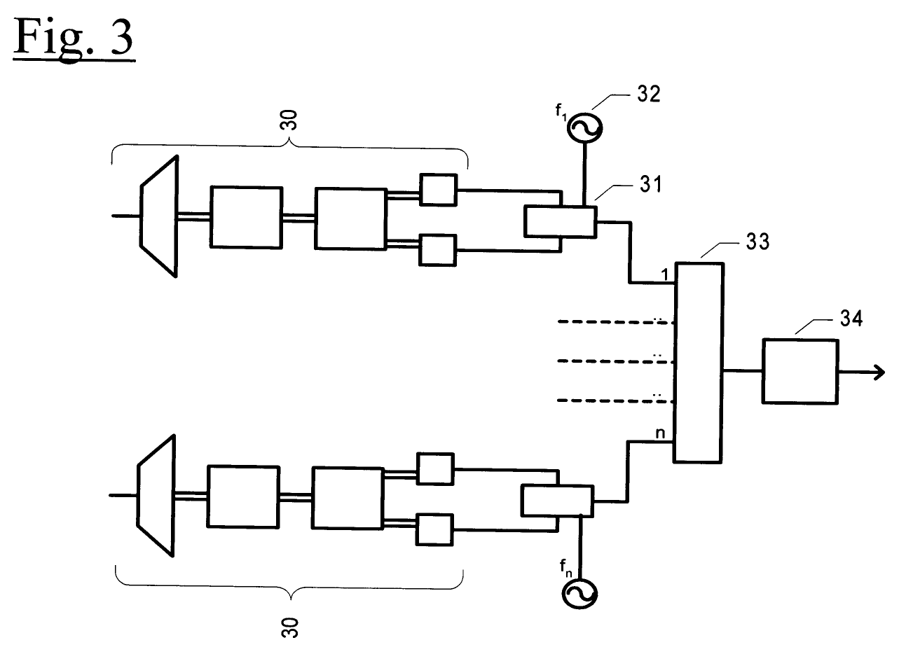

In order to receive the signal generated by the apparatus of FIG. 2, a coherent detection system is required—that is, the phase as well as the amplitude of the received signal may be detected. In a preferred embodiment, shown in FIG. 3, amplitude modulation of the optical signal is utilised, such that coherent reception is not required.

The apparatus referenced by numeral 30 is the same as that referenced by numeral 298 in FIG. 2, and operates according to the same principles previously described. The output of the digital to analogue converters are passed to an electrical I/Q modulator 31, which modulates an electrical carrier tone 32.

In a preferred embodiment multiple sets of the equipment 30 are repeated in parallel. Each electrical modulator is fed with a carrier at a different frequency f1 . . . fn. The output of each modulator is passed to an electrical signal combiner 33 to combine the electrical signals into a single electrical signal. This electrical signal is then passed to an optical modulator 34. Preferably this optical modulator is an amplitude modulator, however a phase modulator is also applicable. If a phase modulator is used coherent reception is once again required.

Utilising one optical modulator for multiple sub-carrier multiplexed signals enables maximum use to be made of the bandwidth of optical modulators. It is possible that the bandwidth of optical modulators exceeds that of the other components in the transmitter, thus by combining multiple signals maximum use is made of all parts of the apparatus.

The capacity of an optical communications system can be further increased via the use of polarisation multiplexing. Since the polarisation of lasers is very well defined, it is possible to combine the signals from two lasers, with orthogonal polarisations, without the signals interfering with one another. Since two signals can be transmitted through the same medium, the capacity of the medium can be doubled. At the receiver the two polarisations are separated to allow independent recovery of the two signals. In a preferred embodiment of the present invention polarisation multiplexing is utilised.

The blocks shown in FIGS. 2 and 3 are shown for purposes of clarity, and do not indicate a preferred configuration.

The choice of number of sub-carriers is an important parameter in the system. The trade-off is between speed and complexity of the electronic Fourier transform system. As the number of carriers increases the parallelism and complexity increases, however the speed of operation required reduces. For example for a 10 Gb/s signal between 8 and 16 sub carriers may be utilised, however more or less may be used as the performance of electronics develops. A further variable is the modulation format applied to each of the sub-carriers. In the example above binary modulation was used, however higher-order formats are possible, thus increasing the number of bits conveyed by each symbol. In general any conventional modulation format can be utilised. If phase modulation is utilised either absolute or differential encoding can be performed. If absolute coding is used a reference phase is transmitted at regular intervals as part of a synchronisation symbol. This reference phase is then used by the receiver to decode the symbols.

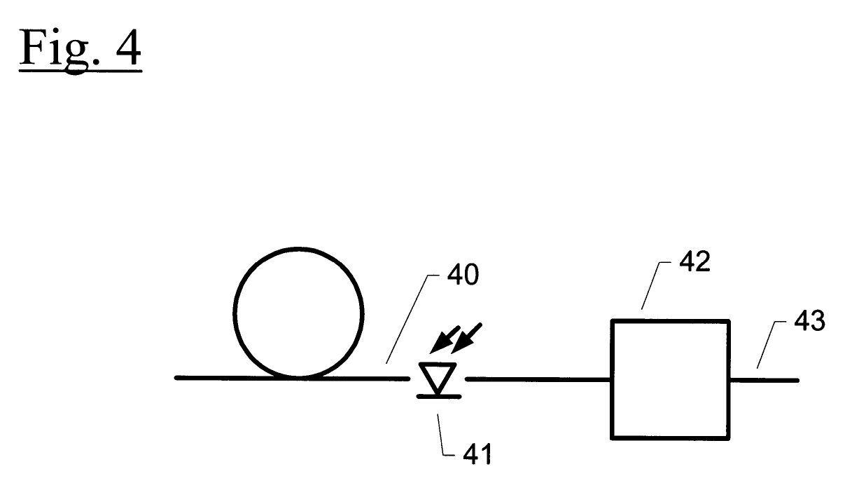

At the receiver the optical composite signal may be received in a number of ways, two examples are described below. FIG. 4 shows the case where all sub-carriers received via optical input 40 are converted to an electrical signal in the same optical to electrical converter 41, whose output is passed to a processor 42. This processes the received signal to retrieve the transmitted data output on electrical output 43.

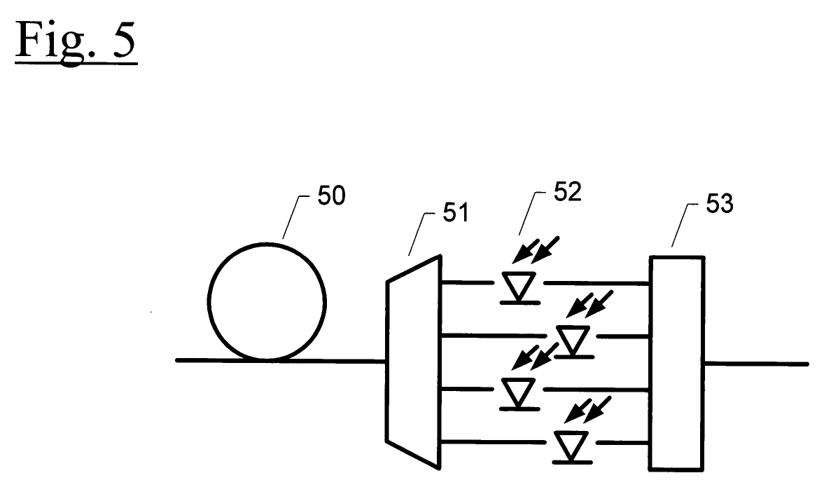

An alternative method of receiving the signal is to optically demultiplex the sub-carriers and receive them individually or as sub-sets, as shown in FIG. 5. The optical input 50 is demultiplexed 51, and each sub-carrier passed to a separate optical to electrical converter 52, converting the light signals to electrical ones. The outputs of the converters are then passed to a processing unit 53 which outputs the original serial data stream. This method has the advantage that each optical receiver only has to receive one subcarrier, and therefore requires a smaller bandwidth, thus being cheaper and easier to manufacture. Since each sub-carrier is available independently in both optical and electrical domains there is the possibility to process each sub-carrier differently. This method is only suitable for receiving an SCM signal with a guard band between sub-carriers to allow optical demultiplexing.

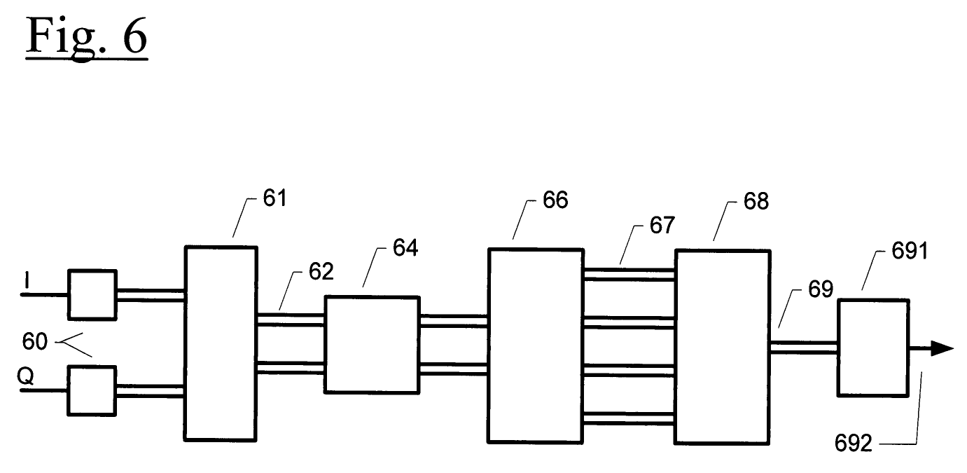

The receiver shown broadly in FIG. 4 will now be described in detail, with reference to FIG. 6.

The receiver described below utilises a Fourier transform integrated over a symbol period, such that it is capable of receiving an OFDM signal. The I and Q components of the sub-carrier multiplexed signal are required as inputs to the receiver. In the case where the optical carrier has been modulated utilising an optical I/Q modulator, a coherent receiver is utilised. In the case where the optical carrier has been amplitude modulated with an I/Q modulated electrical carrier an alternative receiver may be utilised. Apparatus for obtaining the required I & Q components from each type of signal will first be described, before the remainder of the equipment is described, which is common to both.

If I/Q modulation of the optical carrier is utilised, a conventional coherent optical receiver can be utilised to obtain the I and Q components of the signal. Furthermore a polarisation diverse optical receiver may be utilised and combined with maximum likelihood sequence estimation to provide improved performance, as described in co-pending U.S. application Ser. No. 10/425,809 and referred to above.

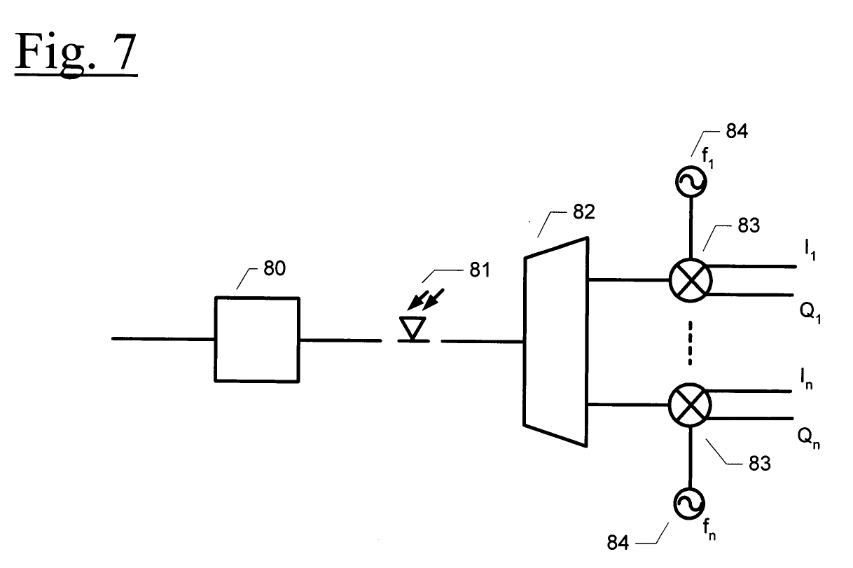

FIG. 7 is a block diagram of apparatus applicable to receiving an amplitude modulated sub-carrier multiplexed optical signal.

In order to receive an amplitude modulated sub-carrier multiplexed signal, only a single side-band of the signal needs to be received. To remove the unwanted side-band the signal is passed through an optical filter 80 with the required spectral shape. Alternatively the optical filter may be placed at the transmitter end of the system, such that the unwanted side-band is not transmitted.

The output of the filter is passed to an optical to electrical converter 81. If multiple sub-carrier multiplexed signals have been combined, as described previously, the electrical signal is now split 82. Each output is passed to an electrical I/Q demodulator 83, driven by a respective electrical local oscillator 84. Each demodulator produces I and Q signals which are then decoded utilising the equipment described below.

In order to provide frequency control of the electrical local oscillators, feedback may be provided from the Fourier transform unit shown as part of the apparatus in FIG. 6.

FIG. 6 shows a block diagram of a digital receiver according to the present invention. The operation of the receiver is described with reference to the same example as used as used previously. I and Q components of the input signal are passed to a pair of Analogue to Digital converters 60, each sampling synchronously, at a rate defined by the transmitter digital to analogue converters. The sampling point may be synchronised with the transmitter, as known in the prior art (Keller et al, Orthogonal Frequency Division Multiplex Synchronization Techniques for Frequency-Selective Fading Channels, IEEE Journal on selected areas in communications, Vol 19, No 6, June 2001). The carrier recovery system 61 acquires the reference tone (if transmitted) for use in decoding the data, and removes any residual carrier. The output 62 of the carrier recovery system consists of pairs of I & Q data in series. This is passed to the de-serialiser 64 which generates substantially parallel words, with each word representing one transmitted symbol. A Fourier transform function is performed by digital signal processor 66 on each word, giving an output every 800 ps in our example. The Fourier transform is performed only on the data-carrying section of the symbol, with the guard interval being discarded to provide improved tolerance to CD and PMD as discussed previously. The output 67 consists of a multi-level representation of the data on each sub-carrier. For example if an 8-bit Fourier transform is performed, each sub-carrier is represented by 8-bits. The decision system 68 then converts these numbers into data, either by a simple decision threshold or using MLSE techniques as described previously. The data can then be processed utilising FEC to provide error detection and correction. The output 69 is then passed to a serialiser 691 which converts the parallel words (in the example case, 8 bits wide) into a substantially serial data stream output on the electrical output 692. Additional equipment may also be included to extract channel state information which can be utilised in the decoding process.

Methods according to the present invention will now be described with reference to the drawings.

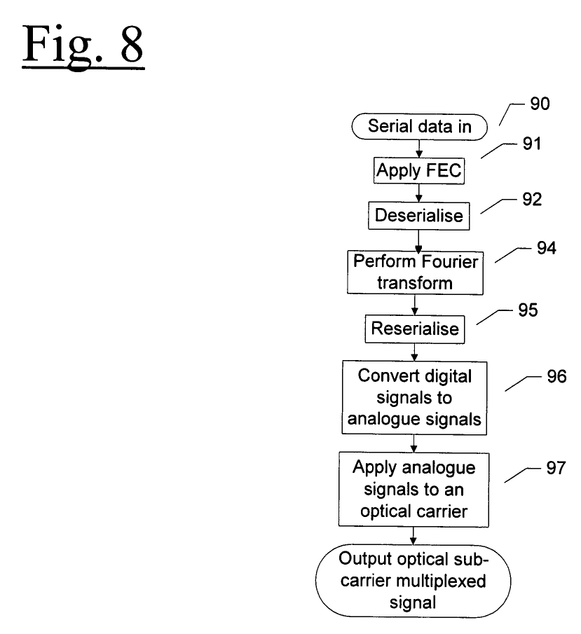

FIG. 8 is a flow diagram showing a method of generating an optical SCM signal according to the present invention. FEC is applied at step 91 to the incoming data 90, and then the data is deserialised at step 92 to generate a substantially parallel electrical data stream. A Fourier transform is then performed on this data at step 94. The output of the Fourier transform function is serialised at step 95 and converted to an analogue signal at step 96. An optical carrier is then modulated with this signal at step 97, producing an optical SCM signal 98.

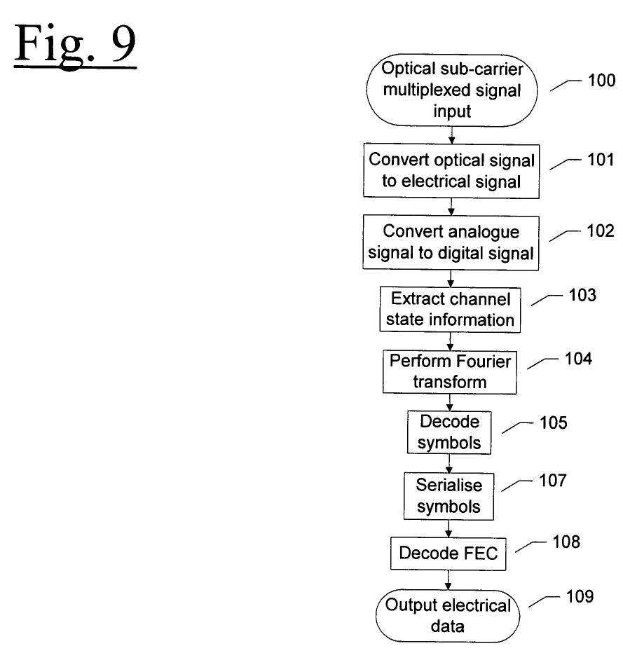

FIG. 9 is a flow diagram showing a method of receiving an optical SCM signal according to the present invention. The optical SCM signal 100 is converted to an electrical signal at step 101 and then is converted to a digital electrical signal at step 102. Channel state information is extracted from the signal at step 103 for use in error correction and detection. A Fourier transform is performed on the data at step 104 to generate a substantially parallel stream of symbols. The symbols are then decoded at step 105, preferably utilising MLSE, to obtain a data stream. The data is serialised at step 107 to obtain a substantially serial data stream. Forward error correction coding is then decoded to detect and correct errors at step 108, producing a substantially serial electrical data stream 109.

In summary an optical communications system utilising a digitally generated sub-carrier multiplexed signal, has been described. Preferred embodiments of transmitter and receiver apparatus utilising Fourier transforms have been described in detail. Furthermore methods of communication utilising SCM, digital generation of SCM signals and digital reception of SCM signals have been described.

1. Apparatus for generating an optical sub-carrier multiplexed signal, comprising
a digital signal processor having a plurality of electrical inputs, in use each receiving an input signal representing data to be carried on a sub-carrier of the optical sub-carrier multiplexed signal, and an electrical output outputting an output signal, and
a modulator having an electrical input, in use receiving the output signal from the digital signal processor, and an optical output, in use outputting the optical sub-carrier multiplexed signal,
wherein the output signal of the digital signal processor is the result of a Fourier transform performed on the input signals.

2. Apparatus according to claim 1 where the spacing of the sub-carriers in the sub-carrier multiplexed signal is substantially equal to an integer multiple of 1/(Symbol period).

3. Apparatus according to claim 1 further comprising a mapper having an electrical input, in use receiving binary data, and a plurality of electrical outputs connected to the electrical inputs of the digital signal processor, wherein the signals carried by the outputs are a representation of the binary data according to a predetermined modulation format.

4. Apparatus according to claim 3 where the predetermined modulation format is a phase modulation format.

5. Apparatus according to claim 3 where the predetermined modulation format is a differential phase modulation format.

6. Apparatus according to claim 3 where the predetermined modulation format is an amplitude modulation format.

7. Apparatus according to claim 3 where the predeteremined modulation format is an amplitude and phase modulation format.

8. Apparatus according to claim 1 the digital signal processor further comprising a serialiser, having a plurality of electrical inputs connected to the electrical outputs of the digital signal processor, and an electrical output in use carrying a signal generated by the serialisation of the signals carried on the plurality of electrical inputs to the serialiser.

9. The apparatus of claim 1 further comprising a digital to analogue converter having an electrical input connected to the electrical output of the digital signal processor, and an electrical output connected to the modulator, in use the output of the digital to analogue converter being an analogue representation of the digital input signal.

10. Apparatus according to claim 1 further comprising an electrical signal generator, connected to an input of the modulator, wherein a small depth modulation is imparted on the optical sub-carrier multiplexed output signal.

11. Apparatus according to claim 1 wherein the modulator is configured to modulate the amplitude and phase of an optical carrier.

12. Apparatus according to claim 11 wherein the modulator comprises two Mach-Zehnder structures, connected to an optical combiner.

13. Apparatus according to claim 1 wherein the modulator comprises
an electrical signal modulator having an electrical signal input, in use receiving the output of the digital signal processor, an electrical carrier input in use receiving a carrier signal, wherein the carrier is modulated in response to the electrical signal input to generate a modulated electrical signal which is output on an electrical output,
an optical modulator having an optical input in use receiving an optical carrier and an electrical input connected to the output of the electrical signal modulator, wherein the optical carrier is modulated in response to the output of the electrical signal modulator.

14. Apparatus according to claim 13 wherein the optical modulator is an optical amplitude modulator.

15. Apparatus according to claim 13 wherein the optical modulator is an optical phase modulator.

16. Apparatus according to claim 1 further comprising a forward error correction coder connected to the digital signal processor, in use applying forward error correction coding to the data.

17. Apparatus for generating an optical signal consisting of a plurality of optical sub-carrier multiplexed signals, the apparatus comprising
a plurality of digital signal processors each having
a plurality of electrical inputs, in use each input receiving an input signal representing data to be carried on a sub-carrier of the optical sub-carrier multiplexed output signal, and
an electrical output carrying an output signal,
wherein, the electrical output signal of each digital signal processor is the result of a Fourier transform performed on the respective inputs of that digital signal processor,
a plurality of electrical signal modulators each having
an electrical signal input, in use receiving the output of a digital signal processor,
an electrical carrier input in use receiving a carrier signal, wherein the carrier is modulated in response to the electrical signal input to generate a modulated electrical signal, and
an electrical output outputting the modulated electrical signal,
an electrical combiner having
a plurality of electrical inputs, in use each input receiving the output of one of the electrical signal modulators, and
an electrical output in use carrying a signal generated by combining the input signals, and,
an optical modulator having
an electrical input in use receiving the output of the electrical combiner,
an optical carrier input, in use receiving an optical carrier, and
an optical output, in use outputting the plurality of optical sub-carrier multiplexed signals.

18. Apparatus according to claim 17 where the optical modulator is an optical amplitude modulator

19. Apparatus according to claim 17 where the optical modulator is an optical phase modulator.

20. An optical transmitter comprising
a digital signal processor having a plurality of electrical inputs, in use each receiving an input signal representing the data to be carried on a sub-carrier of the optical sub-carrier multiplexed signal, and an electrical output outputting an output signal, and
a modulator having an electrical input, in use receiving the output signal from the digital signal processor, and an optical output, in use outputting the optical sub-carrier multiplexed signal,
wherein the output signal of the digital signal processor is the result of a Fourier transform performed on the input signals.

21. Apparatus according to claim 20 where the spacing of the sub-carriers in the sub-carrier multiplexed signal is substantially equal to an integer multiple of 1/(Symbol period).

22. Apparatus for receiving an optical sub-carrier multiplexed signal, the apparatus comprising
an optical to electrical converter, in use receiving the optical sub-carrier multiplexed signal and outputting an electrical signal, and
a digital signal processor having an electrical input, in use receiving the output of the optical to electrical converter, and a plurality of electrical outputs, in use each carrying a signal representing data carried on a sub-carrier of the optical sub-carrier multiplexed signal,
wherein, the outputs of the digital signal processor are the result of a Fourier transform performed on the input signal.

23. The apparatus of claim 22 further comprising a decoder having
a plurality of electrical inputs in use receiving the outputs of the digital signal processor, and
an electrical output, in use outputting binary data.

24. The apparatus of claim 23, the decoder comprising a serialiser having a plurality of inputs receiving the outputs of the digital signal processor, and an output outputting a signal derived by the serialisation of the input signals.

25. The apparatus of claim 23, the decoder comprising a threshold decoder, wherein the output data is determined by the comparison of the input signals with a predetermined value.

26. The apparatus of claim 23 wherein the decoder comprises a maximum likelihood sequence estimation decoder.

27. The apparatus of claim 22, the digital signal processor comprising
a de-serialiser having an electrical input receiving the output of the optical to electrical converter and outputting a plurality of signals obtained by the deserialisation of the input,
a Fourier transform unit having a plurality of electrical inputs, in use receiving the outputs of the de-serialiser, and a plurality of electrical outputs, in use each carrying a signal representing data carried on a sub-carrier of the optical sub-carrier multiplexed signal,
wherein the electrical outputs of the Fourier transform unit are the result of a Fourier transform performed on the inputs.

28. The apparatus of claim 22 further comprising a forward error correction decoder connected to the digital signal processor, in use performing error correction on the data.

29. The apparatus of claim 28 further comprising apparatus to determine channel state information of the sub-carriers.

30. The apparatus of claim 29 wherein the channel state information is utilised by the forward error correction decoder to improve the performance of the error correction.

31. Apparatus according to claim 22 further comprising an optical coupler, having
a plurality of optical inputs, in use one of said inputs receiving the optical sub-carrier multiplexed signal, and another of said inputs receiving the output of an optical local oscillator, and
a plurality of optical outputs, at least one of said outputs being connected to the optical to electrical converter.

32. Apparatus for receiving a plurality of optical sub-carrier multiplexed signals, the apparatus comprising an optical demultiplexer having an optical input in use receiving the plurality of optical sub-carrier multiplexed signals, and a plurality of optical outputs in use each output carrying at least one of the optical sub-carrier multiplexed signals, wherein the outputs are connected to apparatus according to claim 22.

33. Apparatus for receiving a plurality of optical sub-carrier multiplexed signals, the apparatus comprising
an optical to electrical converter having
an optical input, in use receiving the optical sub-carrier multiplexed signals, and
an electrical output in use outputting an electrical signal representative of the amplitude of the optical sub-carrier multiplexed signals,
an electrical splitter having
an electrical input, in use receiving the output of the optical to electrical converter, and
a plurality of electrical outputs, in use each outputting a predetermined fraction of the input signal,
a plurality of electrical demodulators, each having
an electrical input, in use receiving an output of the electrical splitter,
an electrical local oscillator input in use receiving an electrical signal from an electrical oscillator, and
an electrical output, in use outputting a demodulated signal,
wherein each electrical oscillator outputs a signal with a different frequency corresponding to a frequency associated with each of the plurality of sub-carrier multiplexed signals,
a plurality of digital signal processors each having
an electrical input, in use receiving the output of an electrical demodulator, and
a plurality of electrical outputs, in use each carrying a signal representing data carried on a sub-carrier of the optical sub-carrier multiplexed signals,
wherein, the outputs of each digital signal processor are the result of a Fourier transform performed on the respective input signals.

34. A receiver for use in an optical communications system comprising
an optical to electrical converter, in use receiving the optical sub-carrier multiplexed signal and outputting an electrical signal, and
a digital signal processor having an electrical input, in use receiving the output of the optical to electrical converter, and a plurality of electrical outputs, in use each carrying a signal representing data carried on a sub-carrier of the optical sub-carrier multiplexed signal,
wherein, the outputs of the digital signal processor are the result of a Fourier transform performed on the input signal.

35. A method for generating an optical sub-carrier multiplexed signal, having the steps of:
performing a Fourier transform on a plurality of signals, each signal representing data to be carried on a sub-carrier of the optical sub-carrier multiplexed signal, and
modulating an optical carrier with the signal output from the Fourier transform to generate an optical sub-carrier multiplexed signal.

36. A method according to claim 35 wherein the sub-carriers are generated with a spacing substantially equal to an integer multiple of 1/(Symbol period).

37. A method according to claim 35 further comprising the step of receiving electrical data and mapping it according to a predetermined modulation format to form the inputs to the Fourier transform.

38. A method according to claim 35, further comprising the step of applying forward error correction to the data.

39. A method according to claim 35 further comprising the step of serialising the output signals of the Fourier transform.

40. A method for receiving an optical sub-carrier multiplexed signal, having the steps of:
converting the optical signal to an electrical signal, and
performing a Fourier transform on the electrical signal to obtain a plurality of electrical signals, each signal representing the data carried on one of the sub-carriers of the optical sub-carrier multiplexed signal.

41. A method according to claim 40, further comprising the step of serialising the signals output from the Fourier transform to obtain a substantially serial data stream.

42. A method according to claim 40, further comprising the step of decoding the output signals of the Fourier transform according to a threshold decision rule.

43. A method according to claim 40, further comprising the step of applying maximum likelihood sequence estimation to the outputs of the Fourier transform.

44. A method according to claim 43, further comprising the step of decoding forward error correction applied to the data.

45. A method according to claim 44, further comprising the step of obtaining channel state information on the sub-carriers, indicative of the quality of each sub-carrier.

46. A method according to claim 45, further comprising the step of utilising said channel state information to control the behaviour of the forward error correction.

47. A method of optical communication utilising an optical sub-carrier multiplexed signal, having the steps of
performing a Fourier transform on a plurality of signals, each signal representing data to be carried on a sub-carrier of the optical sub-carrier multiplexed signal,
modulating an optical carrier with the signal output from the Fourier transform to generate an optical sub-carrier multiplexed signal,
transmitting the optical sub-carrier multiplexed signal from one location to a second remote location,
converting the optical sub-carrier multiplexed signal to an electrical signal, and
performing a Fourier transform on the electrical signal to obtain a plurality of electrical signals, each signal representing the data carried on one of the sub-carriers of the optical sub-carrier multiplexed signal.

48. An optical signal carrying data, having a plurality of sub-carriers spaced at an integer multiple of 1/(Symbol period).

49. A transmitter comprising a digital signal processor coupled to an optical signal generator, the transmitter being arranged, in use, to generate an optical data signal having a plurality of sub-carriers.

50. A transmitter according to claim 49 wherein the optical data signal is an orthogonal frequency division multiplexed signal.

51. A method of generating an optical data signal having a plurality of sub-carriers, having the steps of:
receiving an electrical data signal,
processing the electrical data in a digital signal processor, and
generating an optical sub-carrier multiplexed signal according to the output of the digital signal processor.

52. A method according to claim 51 wherein the optical data signal is an orthogonal frequency division multiplexed optical signal.

53. A receiver comprising an optical to electrical converter coupled to a digital signal processor, the receiver being arranged, in use, to receive an optical data signal having a plurality of sub-carriers.

54. A receiver according to claim 53 wherein the optical data signal is an orthogonal frequency division multiplexed signal.

55. A method of receiving an optical data signal having a plurality of sub-carriers, having the steps of:
converting the optical data signal to an electrical signal, and
processing the electrical signal in a digital signal processor.

56. A method according to claim 55 wherein the optical data signal is an orthogonal frequency division multiplexed optical signal.

57. An optical communications system comprising an apparatus, transmitter or receiver according to any one of claims 1, 18, 21, 23, 36, 35, 53 or 55.

58. An optical communications system comprising a transmitter and a receiver, in use the transmitter transmitting an optical data signal to the receiver, wherein the optical data signal is an orthogonal frequency division multiplexed signal.

59. Software for carrying out the method of any one of claims 37, 43, 51, 55 or 59.
